(19) United States
(12) Patent Application Publication
(10) Pub. No.: US 2013/0233552 A1
(43) Pub. Date: Sep. 12, 2013

(54) MACROMOLECULAR, AMPHIPHILIC COMPOUNDS AS WATER RETENTION AGENTS FOR CONSTRUCTION CHEMISTRY SYSTEMS, IN PARTICULAR FOR WELL CEMENTING

(71) Applicants: Yulia Fogel, Traunstein (DE); Mario Vierle, Wasserburg (DE); Andrea Assmann, Unterreit (DE); Mathias Bauer, Altenmarkt (DE); Gerhard Albrecht, Prien am Chiemsee (DE)

(72) Inventors: Yulia Fogel, Traunstein (DE); Mario Vierle, Wasserburg (DE); Andrea Assmann, Unterreit (DE); Mathias Bauer, Altenmarkt (DE); Gerhard Albrecht, Prien am Chiemsee (DE)

(73) Assignee: BASF SE, Ludwigshafen (DE)

(21) Appl. No.: 13/874,176

(22) Filed: Apr. 30, 2013

Related U.S. Application Data
(62) Division of application No. 13/025,329, filed on Feb. 11, 2011.
(60) Provisional application No. 61/307,462, filed on Feb. 24, 2010.

(51) Int. Cl. C04B 24/28; E21B 33/13

(52) U.S. Cl. CPC C04B 24/282; E21B 33/13
USPC 166/292; 528/85; 528/44

(57) ABSTRACT

The water retention agents according to the invention are outstandingly suitable as additives in construction chemistry systems and in the development, exploitation and completion of underground mineral oil and natural gas deposits and in deep wells, their effect being particularly advantageous at increased temperatures and because of their lack of influence on the rheological properties of the well slurries.

This patent application claims the benefit of pending U.S. provisional patent application Ser. No. 61/307,462 filed Feb. 24, 2010 incorporated in its entirety herein by reference.

The present invention relates to a water retention agent for construction chemistry systems, a process for the preparation of a macromolecular, amphiphilic compound suitable as a water retention agent, the use of this compound as a water retention agent in construction chemistry systems and in the development, exploitation and completion of underground mineral oil and natural gas deposits and in deep wells, a construction material mixture containing this compound, a construction material formulation containing water and said construction material mixture, and a structure produced with the use of this construction material formulation.

In the construction chemistry sector, various copolymers are frequently used as water retention agents, which are also referred to as fluid loss additives. A specific field of use in this context is the cementing of wells in the development, exploitation and completion of underground mineral oil and natural gas deposits and in deep wells.

Water retention agents or fluid loss additives have the function of reducing the water release of a cement slurry. This is of importance in particular in the area of mineral oil and natural gas exploration since cement slurries which substantially comprise cement and water are pumped through the annular space between the so-called casing and the well wall in the cementing of the wells. During this procedure, amounts of water may be released from the cement slurry to the underground formation. This is the case in particular when the cement slurry flows past porous rock strata during the cementing of the well. The alkalized water originating from the cement slurry can then cause clays to swell in the formations and form calcium carbonate precipitates with carbon dioxide from the natural gas or mineral oil. As a result of these effects, the permeability of the deposits is reduced and consequently the production rates are also adversely affected.

In addition, as a result of the release of water to the porous underground formations, the cement slurries no longer solidify homogeneously and thus become permeable to gases and to liquid hydrocarbons and water. This subsequently leads to the escape of the fossil energy carriers through the annular space filled with porous cement.

Attempts have therefore long been made to reduce such water losses of the cement slurries used to a tolerable minimum.

EP 0 116 671 A1 describes, for example, a cement slurry for deep wells which is intended to reduce the water loss with its content of copolymers. Acrylamides and in particular acrylamidomethylpropanesulphonic acid (AMPS) constitute an important constituent of the copolymers used. According to this document, the cement slurries should contain between 0.1 and 3% by weight of the suitable copolymers.

EP 1 375 818 A1 is concerned with the cementing of wells and a composition suitable for this purpose. A polymer additive which, in addition to AMPS, additionally contains maleic acid, N-vinylcaprolactam and 4-hydroxybutyl vinyl ether is likewise used for fluid loss control.

A copolymer according to U.S. Pat. No. 4,015,991 is likewise based on AMPS and partly hydrolysed acrylamide. The copolymer described in this patent is also said to improve the water retention capacity in cementitious compositions. The cementing of wells is mentioned as a primary field of use.

U.S. Pat. No. 4,515,635 describes polymers which are stable to hydrolytic influences and can also be used in the cementing of wells. In the respective uses, the water loss is said to be reduced by the polymers described. The copolymers substantially comprise N,N-dimethylacrylamide and AMPS. Similar polymers are described in U.S. Pat. No. 4,555,269. The copolymers described here have a specific ratio between the monomer components N,N-dimethylacrylamide and AMPS.

The US patents mentioned below also relate to compounds having water retention properties:

The water-soluble copolymers according to U.S. Pat. No. 6,395,853 B1 contain, inter alia, acrylamides and AMPS. To the forefront of this patent is a process for reducing the water loss in a slurry which is used for extracting mineral oil. The cementing of wells and completion and the drilling mud preceding these process steps are mentioned in particular in this context.

U.S. Pat. No. 4,700,780 focuses on a process for reducing the water loss in cement-containing compositions which also comprise defined salt concentrations. The water retention agent is once again a polymer or polymer salt of AMPS, it being necessary in this case for the building blocks styrene and acrylic acid also to be present.

This multiplicity of known copolymers or graft copolymers have, as already discussed briefly, a property profile which differs in each case and has specific advantages and disadvantages, depending on their monomer composition. A general weakness which is peculiar to most of these ionic polymers is that their water retention effect declines in the presence of divalent salts as typically occur in sea water which is frequently used for stirring the cement slurries in the case of offshore oil and gas wells and/or at high temperatures above about 90° C., it also being possible for a total loss of effect to occur.

As demonstrated above by way of example, intensive attempts have long been made to provide novel molecules or polymers whose water retention capacity is stable in particular in the area of oil and gas exploration, so that an advantageous price/performance ratio can be assumed.

Since the salt and temperature stability in specific applications is still in need of improvement, the object of the present invention is substantially to provide novel molecules which are based on tried and tested components and show substantial improvements in particular in the presence of divalent salts and at high temperatures.

This object is achieved by the features of the independent claims. The dependent claims relate to preferred embodiments.

It was surprisingly found that, in these applications, the macromolecular amphiphilic, uncharged compounds according to the invention have water retention properties which are virtually identical to those of reference samples currently commercially available, but have no disadvantageous influence on the rheology of the slurries. Furthermore, an excellent temperature stability was found, which ensures efficiency of the water retention agents over a wide temperature range. As uncharged molecules, these compounds are not subject to interaction with salts of divalent metals.

Compounds of this type are described in our still unpublished International Patent Application PCT/EP2009/063079 of Aug. 10.2009 with priority of Sep. 10.2008 as adsorption blockers in construction material mixtures which contain cement, aggregates and plasticizers in variable proportions by weight. When used, these compounds prevent an undesired adsorption of the plasticizer onto the aggregates used, which are adsorptive with respect to the plasticizer.

The present invention relates to a water retention agent for construction chemistry systems, comprising at least one macromolecular, amphiphilic compound having structural units of type A, D and E and at least one D-E-A sequence in the molecule, obtainable by means of reaction of reactive isocyanate groups with groups reactive towards isocyanates, characterized in that
E represents a structural unit which is derived from a polyisocyanate having at least two reactive isocyanate groups,
D represents a structural unit which is derived from a hydrophobic compound having at least one group reactive towards isocyanates, selected from —OH, —NH₂, —COOH, —NH—R*, in which R* represents a branched or straight-chain C₂₋₂₈-alkyl group (preferably ethyl, propyl, butyl, hexyl, (2-ethyl)hexyl, heptyl, octyl, decyl, tridecyl, octadecyl or cyclohexyl) and
A represents a structural unit which is derived from a hydrophilic compound having at least one group reactive towards isocyanates, selected from —OH, —NH₂, —COOH.

The statement that the structural units A, D and E are “derived” from the corresponding compounds comprises the possibility that said compounds were reacted with one another but also comprises the possibility that other compounds which react analogously and lead to the same structural units were used for the synthesis.

On the basis of said components, these molecules can be prepared very economically. Preferably, the macromolecular, amphiphilic compound contains 3 to 10 structural units of the type A, D and E in the molecule, selected independently of one another.

In the context of the present invention, hydrophobic is to be understood as meaning those compounds which, at a temperature of 20° C., have a water solubility (under atmospheric pressure) of less than 1 g/litre of water, preferably of less than 0.3 g/litre of water.

According to the invention, those compounds which, at a temperature of 20° C., have a water solubility (under atmospheric pressure) of more than 10 g/litre of water, preferably of more than 30 g/litre of water, should be regarded as being hydrophilic.

Frequently, the macromolecular, amphiphilic compound is present according to one of the structure types

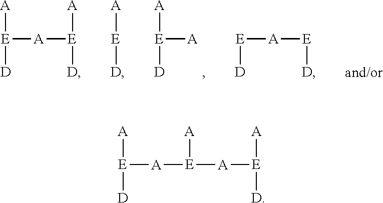

In a preferred embodiment of the invention, the structural units of the type A, which bridge structural units of the type E, contain ether groups, and the compounds from which they are derived have molecular weights of 400 to 15000, preferably of 1000 to 5000, g/mol.

Preferably, the structural unit A is derived from a polyethylene glycol or methylpolyethylene glycol or a (block/stat)copoly(ethylene/propylene) glycol or the monomethyl ether thereof, having a water solubility at 20° C. of at least 10 g/litre of water.

Preferably, the structural unit D is derived from a polyisobuteneamine and/or from polyisobutenesuccinic acid or the anhydride thereof.

Preferably, the structural unit E is derived from a trimeric polyisocyanate containing three reactive isocyanate groups, such as, for example, trimeric hexamethylene diisocyanate.

The macromolecular, amphiphilic compound preferably has a molecular weight of 1000 to 100000, particularly preferably of 5000 to 50000 and in particular of 10000 to 30000 g/mol.

The water retention agent according to the invention is preferably used in the form of an aqueous emulsion having a solids content of more than 30% by weight. However, even when used in “dry form”, a residual moisture of a few percent would have to be expected.

Preferably, the water retention agent comprises 31-99% by weight of the (at least one) macromolecular, amphiphilic compound and 69-1% by weight of water. The formulation “of at least one macromolecular, amphiphilic compound” is intended to express the fact that mixtures of different macromolecular, amphiphilic compounds which in each case by themselves are covered by the above definitions may be present in the water retention agent in the meaning of the present invention.

Below, the chemical compounds from which the structural units A, E and D can be derived are to be explained in more detail:

### Structural Unit A:

From the group consisting of polyalkylene oxide compounds, molecules of the structure (I′ a) are used:

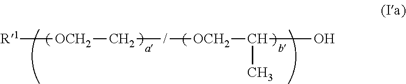

in which
R′¹=is —H or a straight-chain or branched and optionally unsaturated aliphatic hydrocarbon radical having 1 to 12 C atoms and
a′=is 0 to 250 and
b′=is 0 to 250,
with the proviso that a′ and b′ are chosen as a function of the molar mass so that the polyalkylene oxide compound has a water solubility of at least 10 g/l at 20° C.

Preferably, R′¹ in formula (I′ a) represents —CH₃ (methyl), —CH₂—CH₂—CH₂—CH₃ (n-butyl), CH═CH₂— (vinyl) and CH₂═CH—CH₂— (allyl), particularly preferably —CH₃. The ethylene or propylene units may be distributed blockwise or randomly.

Preferably, a′ is between 20 and 200, particularly preferably between 20 and 150, and b′ is between 0 and 20, particularly preferably between 0 and 10. Methylpolyethylene oxides which are commercially available, for example, under the trade names Polyglykol M or Pluriol® A are particularly preferred.

Furthermore, polyoxyalkylene compounds of the formula (I′b) and (I′c) are suitable:

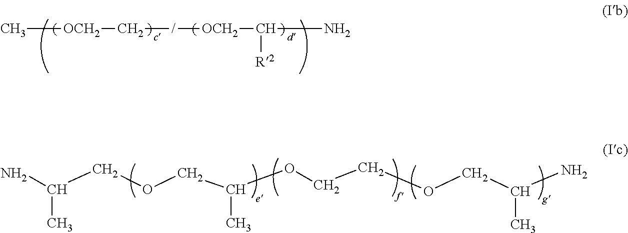

These are or commercially available, for example, under the trade names Jeffamine® M-1000 or Jeffamine® ED-600.

Here:

R′² denotes —H, —CH₃,
c′, f′ denote an integer from 1 to 100, also independently of one another,
d′, e′, g′ denote an integer from 0 to 100, also independently of one another,
with the proviso that the ratios c′/d′ and f′/(e′+g′) are chosen so that the compound has a water solubility of at least 10 g/l at 20° C.

### Structural Unit D:

Polyisobutene derivatives which can be prepared by functionalization of olefinically terminated polyisobutenes. Polyisobuteneamines, polyisobutene succinates and polyisobutene phenols are suitable here. These functionalized polyisobutenes are commercially available, for example, under the name Kerocom® PIBA (polyisobuteneamine) and Glissopal® SA (polyisobutene succinate). Preferably, polyisobuteneamine or polyisobutenesuccinic acid is used, particularly preferably having an average molar mass of 300 to 3000 g/mol.

Alkylpolyoxyalkylene derivatives, such as, for example, methylpolypropylene glycols having average molar masses of >800 g/mol and analogous butylpolyoxypropylene derivatives. Furthermore, methylpolyalkoxylene derivatives which are composed of polyoxyethylene and polyoxypropylene units which may be arranged randomly or blockwise have proved useful. The molar ratio of oxyethylene to oxypropylene units is chosen so that the resulting alkylpolyoxyalkylene glycols have a water solubility of less than 1 g/l at 20° C.

Tetramerbutene derivatives which can be obtained by functionalization of butene tetramer. Butene tetramer succinic acid, butenol tetramer and butenediol tetramer are preferably used, particularly preferably butenol tetramer.

Fatty acids or fatty acid mixtures, such as, for example, tall oil fatty acid, stearic acid, palmitic acid, sunflower oil fatty acid, coconut oil fatty acid (C₈₋₁₈), coconut oil fatty acid (C₁₂₋₁₈), soya oil fatty acid, linseed oil fatty acid, dodecanoic acid, oleic acid, linoleic acid, palm kernel oil fatty acid, palm oil fatty acid, linolenic acid and/or arachidonic acid. Tall oil fatty acid and stearic acid are to be regarded as being preferred here.

Alkyl alcohols which have a low water solubility or are water-insoluble and are from the group consisting of C₆₋₂₈-alcohols, such as, for example, 1-eicosanol, 1-octadecanol, 1-hexadecanol, 1-tetradecanol, 1-dodecanol, 1-decanol, 1-octanol and 1-hexanol, where 1-octanol and 1-decanol and 1-dodecanol are to be regarded as being preferred.

N-Alkylamines which have a low water solubility or are water-insoluble, such as, for example, N-butylamine, N-pentylamine, N-hexylamine, N-octylamine, N-decylamine and N-tridecylamine. N-Hexylamine and N-octylamine are preferably used.

N,N-Dialkylamines which have a low water solubility or are water-insoluble, such as, for example, N,N-ethylhexylamine, N,N-dibutylamine, N,N-dipentylamine, N,N-dihexylamine, N,N-dioctylamine, N,N-(2-ethylhexyl)amine, N-methyl-N-octadecylamine and N,N-didecylamine. N,N-Ethylhexylamine and N,N-dipentylamine are preferred here.

Polydimethylsiloxanes of the general formula (II′a):

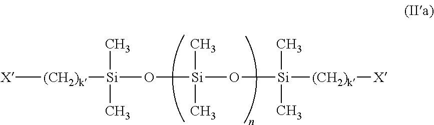

in which
X′ denotes —OH, —NH₂, —SH, —NHR′¹³,
R′³ denotes —H, —CH₃, —C₂H₅,
n denotes 1 to 50, preferably 10 to 30, and
k′ denotes 1 to 6.

Perfluoroalkylethanols of the general formula R′₄—CH₂—CH₂—OH where radical R′₄═CF₃(CF₂)_{I′}—, in which I′ represents an integer from 6 to 18. Mixtures having different radicals R′₄ are preferred; the commercially available perfluoroalkylethanol Fluowet® EA 612 is particularly preferably used.

### Structural Unit E:

Polyfunctional isocyanates known to the person skilled in the art by the name “coating polyisocyanates” and based on bis(4-isocyanatocyclohexyl)methane (H₁₂MDI), 1,6-diisocyanatohexane (HDI), 1-isocyanato-5-isocyanatomethyl-3,3,5-trimethyl-cyclohexane (IPDI) are used.

Modified polyisocyanates, which are obtainable, for example, by hydrophilic modification of “coating polyisocyanates” based on 1,6-diisocyanatohexane (HDI).

1-Isocyanato-5-isocyanatomethyl-3,3,5-trimethylcyclohexane (IPDI), bis(4-isocyanatocyclohexyl)methane (H₁₂MDI), 1,3-bis(1-isocyanato-1-methylethyl)benzene (m-TMXDI), 1,6-diisocyanatohexane (HDI) and the higher homologues thereof or industrial isomer mixtures of the individual aliphatic polyisocyanates are preferably used from the group consisting of the aliphatic polyisocyanate compounds, while in particular 2,4-diisocyanatotoluene (TDI), bis(4-isocyanatophenyl)methane (MDI) and optionally the higher homologues thereof (polymeric MDI) or industrial isomer mixtures of the individual aromatic polyisocyanates are preferably used from the group consisting of the aromatic polyisocyanates. HDI trimers, which are commercially available under the name Desmodur® N3600 or Desmodur® N3400, are particularly preferably used.

The present invention furthermore relates to a process for the preparation of a macromolecular, amphiphilic compound according to the above definition which is suitable as a water retention agent, characterized in that a polyisocyanate having at least two reactive isocyanate groups, a hydrophobic compound having at least one group reactive towards isocyanates, selected from —OH, —NH₂, —COOH, —NH—R*, in which R* represents a branched or straight-chain C₂₋₂₈-alkyl group, and a hydrophilic compound having at least one group reactive towards isocyanates, selected from —OH, —NH₂, —COOH, are reacted with one another, with the proviso that the reaction of the components is effected by reaction of the reactive isocyanate groups with the groups reactive towards isocyanates.

This preparation can be effected by a procedure in which first the individual component according to the structural unit E is reacted with the individual component according to the structural unit A and the reaction product obtained is then reacted with the individual component according to the structural unit D. Alternatively, however, it is also possible first for E to be reacted with D and then the reaction product to be reacted with A.

The NCO/μequivalent ratio, based on the free groups reactive towards isocyanates (μ=—OH, —NH₂, —NH—R*, —COOH), can be varied within wide limits. According to a preferred embodiment, however, the polyisocyanate compound is used in an amount such that
the NCO/μ equivalent ratio, based on the free groups μ reactive towards isocyanates, in the reaction product of isocyanate component according to E and the reactive component according to A is 1.0 to 3.0
the NCO/μ equivalent radio, based on the free groups μ reactive towards isocyanates, in the reaction product with the reactive component according to D is 0.3 to 2.0
   or that
the NCO/μ equivalent ratio, based on the free groups μ reactive towards isocyanates, in the reaction product of isocyanate component according to E and the reactive component according to D is 1.0 to 3.0
the NCO/μ equivalent ratio, based on the free groups μ reactive towards isocyanates, in the reaction product with the reactive component according to A is 0.5 to 2.0.

The reaction can also be carried out as follows:

Reaction of the polyisocyanate component according to E with a hydrophilic component according to A without a solvent in the temperature range from 20 to 150° C.,

subsequent addition of the hydrophobic component according to D at temperatures of 20 to 150° C. and
final reaction of the reaction product with the component according to A at temperatures of 20 to 150° C.;
or
reaction of the polyisocyanate component according to E with a hydrophobic component according to D without a solvent in the temperature range from 20 to 150° C. and final reaction of the reaction product with the component according to A at temperatures of 20 to 150° C.

Preferably, the reaction of the isocyanate component according to E with the reactive component according to A and/or D is effected at temperatures of 20 to 150° C., it being possible for the reaction optionally to be effected in the presence of a catalyst. Thus, it has proved to be particularly advantageous to rely on catalysts, such as, for example, dibutyltin dilaurate (T12-DBTL), in the reaction of the isocyanate component according to E with the reactive components according to A and/or D.

If the macromolecular, amphiphilic compound contains at least two structural units of the type A, D and/or E in the molecule, it may be said that A, D and/or E may in each case be identical or different.

It has been found that the macromolecular, amphiphilic compound according to the above definition exhibits an outstanding effect as a water retention agent. For this reason, the present invention furthermore relates to the use of this compound as a water retention agent in construction chemistry systems and in the development, exploitation and completion of underground mineral oil and natural gas deposits and in deep wells.

Said compound is preferably used as an additive for inorganic, in particular hydraulic, binders, especially in the offshore sector.

The present invention furthermore relates to a construction material mixture containing 31 to 98% by weight of an inorganic binder, 0 to 68% by weight of aggregate and 0.005 to 5% by weight, in particular 0.05 to 1% by weight, of the macromolecular, amphiphilic compound according to the above definition.

The inorganic binder is preferably present as cement. The aggregate is preferably present in the form of sand, gravel and/or stones.

The present invention furthermore relates to a construction material formulation containing water and said construction material mixture, preferably in the form of a cement slurry, in particular having a water/cement value of 0.4 to 0.6.

Finally, a structure produced with the use of this construction material formulation is claimed.

In summary, it may be stated that the proposed macromolecular, amphiphilic compound is outstandingly suitable as water retention agent, in particular because of the small influence on the rheology of the well cement slurries and the significantly increased temperature stability in the range above about 90° C. and because of its insensitivity to salts of divalent metals.

The present invention is now explained in more detail with reference to the following examples:

### EXAMPLES

### Preparation Example 1

### FLA 1

12.70 g of trimeric hexamethylene diisocyanate (Desmodur® N3600) are initially taken with 0.08 g of dibutyltin dilaurate (T-12 DBTL) at 55° C. in a 250 ml three-necked glass flask having a dropping funnel, stirrer and inert gas connection. 115.70 g of hot methylpolyethylene glycol having an average molar mass of 5000 g/mol are added dropwise with stirring within 20 minutes. Thereafter, stirring is effected for 25 min at 60-65° C. and 12.34 g of polyglycol B01/20 (polypropylene glycol monobutyl ether, commercial product of Clariant AG) are then metered in within 20 min. 9.26 g of polyethylene glycol having an average molar mass of 600 g/mol are now added, and the reaction mixture is then heated to 80° C. and stirred for a further 4 h at this temperature. Thereafter, the reaction product is introduced into 305 g of water and emulsified with stirring. A milky white emulsion having a solids content of 33% by weight is obtained.

### Preparation Example 2

### FLA 2

17.76 g of trimeric hexamethylene diisocyanate (Desmodur® N3600) are initially taken with 0.08 g of dibutyltin dilaurate (T-12 DBTL) at 40° C. in a 250 ml three-necked glass flask having a dropping funnel, stirrer and inert gas connection. 97.1 g of hot methylpolyethylene glycol having an average molar mass of 3000 g/mol are added dropwise with stirring within 20 minutes. Thereafter, stirring is effected for 25 min at 45-50° C. and 34.2 g of Kerocom® PIBA 03 (polyisobuteneamine, commercial product of BASF SE) are then metered in within 20 min. 12.9 g of polyethylene glycol having an average molar mass of 600 g/mol are now added, and the reaction mixture is then heated to 80° C. and stirred for a further 4 h at this temperature. Thereafter, the reaction product is introduced into 330 g of water and emulsified with stirring. A milky white emulsion having a solids content of 33% by weight is obtained.

### Preparation Example 3

### FLA 3

17.71 g of trimeric hexamethylene diisocyanate (Desmodur® N3600) are initially taken with 0.08 g of dibutyltin dilaurate (T-12 DBTL) at 48° C. in a 250 ml three-necked glass flask having a dropping funnel, stirrer and inert gas connection. 96.80 g of hot methylpolyethylene glycol having an average molar mass of 3000 g/mol are added dropwise with stirring within 12 minutes. Thereafter, stirring is effected for 25 min at 60-65° C. and 25.81 g of polyglycol B01/20 (polypropylene glycol monobutyl ether, commercial product of Clariant AG) are then metered in within 20 min. 9.68 g of polyethylene glycol having an average molar mass of 600 g/mol are now added, and the reaction mixture is then heated to 80° C. and stirred for a further 4 h at this temperature. Thereafter, the reaction product is introduced into 305 g of water and emulsified with stirring. A milky white emulsion having a solids content of 33% by weight is obtained.

### Example of Use 1

The fluid loss was determined according to API Recommended Practice 10B at 140 and 190° F. (60 and 88° C.) in the following slurry. The results are reproduced in Table 1, reference being made here in particular to the very low viscosity of the cement slurry formulated with water retention agent FLA 1 according to the invention:

800 g of cement (class H)
352 g of distilled water
0.5% by weight of dispersant¹ Melcret® K2F²
1 ml of tributyl phosphate (antifoam)
0.5% by weight of water retention agent¹ FLA 1 or reference polymer³

TABLE 1

| | FANN 35, rpm | | | | | | | Fluid loss |
|---|---|---|---|---|---|---|---|---|
| | T, | | | | | | | under 70 bar, |
| Molecule | (° F.) | 300 | 200 | 100 | 6 | 3 | 600 | (ml/30 min) |
| Reference³ | 140 | 60 | 42 | 22 | 2 | 1 | 109 | 114 |
| | 190 | 53 | 36 | 19 | 2 | 1 | 94 | 222 |
| FLA 1 | 140 | 8 | 6 | 3 | 1 | 1 | 21 | 52 |
| | 190 | 6 | 4 | 3 | 2 | 1 | 15 | 52 |

¹per cent by weight of solid, based on the weight of cement taken
²commercial product of BASF SE
³commercially available fluid loss additive Polytrol ® FL 32 (commercial product of BASF SE)

### Example of Use 2

The fluid loss was determined according to API Recommended Practice 100 at 140 and 190° F. (60 and 88° C.) in the following slurry; the results are reproduced in Table 2:

500 g of cement (class H)
250 g of distilled water
175 g of sand
1 ml of tributyl phosphate (antifoam)
Reference polymer² or polymer according to the invention, for doses, see Table 2

TABLE 2

| | | | | | | | | | Fluid loss |
|---|---|---|---|---|---|---|---|---|---|
| | Dose¹ | FANN 35, rpm | | | | | | | under 70 bar, |
| Molecule | (% by wt.) | T, (° F.) | 300 | 200 | 100 | 6 | 3 | 600 | (ml/30 min) |
| Reference² | 0.5 | 140 | — | 249 | 146 | 28 | 22 | — | 263 |
| Reference² | 0.5 | 190 | — | 251 | 143 | 25 | 20 | — | 280 |
| Reference² | 1.0 | 140 | — | — | — | 50 | 36 | — | 214 |
| FLA 1 | 0.5 | 140 | 151 | 104 | 55 | 7 | 6 | 273 | 58 |
| FLA 1 | 0.5 | 190 | 130 | 89 | 48 | 7 | 6 | 245 | 80 |
| FLA 1 | 1.0 | 140 | 176 | 118 | 61 | 7 | 4 | — | 32 |
| FLA 1 | 1.0 | 190 | 114 | 76 | 41 | 6 | 5 | 210 | 40 |
| FLA 2 | 1.0 | 140 | 181 | 126 | 67 | 8 | 7 | — | 56 |
| FLA 2 | 1.0 | 190 | 137 | 95 | 51 | 8 | 7 | 249 | 102 |
| FLA 3 | 1.0 | 140 | 181 | 123 | 63 | 7 | 6 | — | 34 |
| FLA 3 | 1.0 | 190 | 113 | 76 | 41 | 7 | 5 | 215 | 70 |

¹Percent by weight of solid, based on the weight of cement taken
²Commercially available fluid loss additive Polytrol ® FL 32 (commercial product of BASF SE)

1-19. (canceled)

20. A method for cementing an oil or gas well comprising the steps of:
adding a water retention agent to a construction chemistry system comprising a cement in an amount sufficient to provide water retention in the resultant well cement;
wherein the water retention agent comprises at least one macromolecular, amphiphilic compound having structural units of the type A, D and E and at least one D-E-A sequence in the molecule, obtainable by means of reaction of reactive isocyanate groups with groups reactive towards isocyanates,
wherein E is a structural unit which is derived from a polyisocyanate having at least two reactive isocyanate groups,
D is a structural unit which is derived from a hydrophobic compound having at least one group reactive towards isocyanates, selected from —OH, —NH₂, —COOH, —NH—R*, in which R* is a branched or straight-chain C₂₋₂₈-alkyl group, and
A is a structural unit which is derived from a hydrophilic compound having at least one group reactive towards isocyanates, selected from the group consisting of —OH, —NH₂, —COOH; and cementing the oil well or gas well with the well cement.

21. The method of claim 20, wherein the construction material mixture 31 to 98% by weight of the cement.

22. The method according to claim 21, wherein the well cement further comprises up to 68% by weight of an aggregate.

23. The method according to claim 22, wherein the aggregate is selected from the group consisting of sand, gravel and stones.

24. The method according to claim 20, wherein the well cement comprises water.

25. The method according to claim 24, wherein the well cement is in the form of a cement slurry having a water/cement value of 0.4 to 0.6.

26. The method according to claim 20, wherein the macromolecular, amphiphilic compound has 3 to 10 structural units of the type A, D and E in the molecule, selected independently of one another.

27. A water retention agent according to claim 20, wherein the macromolecular, amphiphilic compound is present according to at least one of the structure types

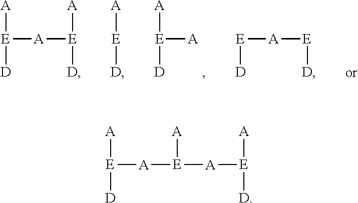

28. The method according to claim 20, wherein the structural units of the type A, which bridge structural units of the type E, contain ether groups, and the compounds from which they are derived have molecular weights of 400 to 15,000 g/mol.

29. The method according to claim 20, wherein the structural unit A is derived from a polyethylene glycol, a methylpolyethylene glycol, a (block/stat)copoly(ethylene/propylene) glycol or the monomethyl ether thereof, having a water solubility at 20° C. of at least 10 g/l.

30. The method according to claim 20, wherein the structural unit D is derived from at least one of a polyisobuteneamine or from polyisobutenesuccinic acid.

31. The method according to claim 20, wherein the structural unit E is derived from a trimeric polyisocyanate containing three reactive isocyanate groups.

32. The method according to claim 20, wherein the macromolecular, amphiphilic compound has a molecular weight of 1000 to 100,000 g/mol.

33. The method according to claim 20, comprising 31-99% by weight of the macromolecular, amphiphilic compound and 69-1% by weight of water.

34. The method according to claim 20, wherein the water retention agent is prepared by a process comprising reacting a polyisocyanate having at least two reactive isocyanate groups with
a hydrophobic compound having at least one group reactive towards isocyanates, selected from —OH, —NH₂, —COOH, —NH—R*, in which R* is a branched or straight-chain C₂₋₂₈-alkyl group, and a hydrophilic compound having at least one group reactive towards isocyanates, selected from —OH, —NH₂, —COOH,
wherein the reaction is effected by reaction of the reactive isocyanate groups with the groups reactive towards isocyanates.
